(19) United States
(12) Patent Application Publication
(10) Pub. No.: US 2012/0189401 A1
(43) Pub. Date: Jul. 26, 2012

(54) FASTENING STRUCTURE

(76) Inventor: Ming-Chung CHIU, Keelung City (TW)

(21) Appl. No.: 13/011,548

(22) Filed: Jan. 21, 2011

(51) Int. Cl. F16B 37/04

(52) U.S. Cl. 411/103

(57) ABSTRACT

A fastening structure includes a thin, light weight, low torque metal plate member having a mounting through hole, and a fastening member, which has a shank body, a mounting flange extending around the periphery of the bottom end of the shank body and riveted to the mounting through hole and a screw hole on the shank body for the fastening of an external screw member to secure an external circuit board to the top end of the shank body at a distance from the plate member. The mounting flange has a tapered peripheral wall reducing gradually upwardly from the bottom end of the shank body toward the top end thereof and riveted to a mounting through hole of the plate member and a step located on the topmost edge of the tapered peripheral wall around the periphery of the shank body and kept in flush with the top wall of the plate member.

### BACKGROUND OF THE INVENTION

1. Field of the Invention

The present invention relates to a fastening structure for the mounting of a circuit board and more particularly, to such a fastening structure, which comprises a metal plate member having a mounting through hole, and a fastening member having a shank body inserted through the mounting through hole and a tapered flange extending around the bottom end of the shank body and riveted to the mounting through hole of said metal plate member.

2. Description of the Related Art

Screws and copper columns are commonly used in an electronic product (such as personal computer, notebook computer, mobile telephone, palmtop game machine, or any other mobile product) to fasten plate members together (for example, to fasten a circuit board to a metal frame shell.) During installation, thread the bottom screw rod of each copper column to one respective screw hole on the metal frame shell, and then insert a respective screw through each mounting through hole on the circuit board and then thread each screw into the screw hole on one respective copper column at the metal frame shell, thereby affixing the circuit board to the copper columns at the metal frame shell and keep the circuit board at a distance from the metal frame shell. This mounting procedure is complicated and requires much labor and time.

In order to save the installation labor and time, a riveting technique is employed to rivet fastening members to respective mounting through holes of a metal frame shell. After riveting of the fastening members to the metal frame shell, screws can be inserted through respective mounting through holes of a circuit board and then threaded into the screw hole on each of the fastening members at the metal frame shell to affix the circuit board to the top ends of the fastening member. According to this design, the riveting portion of each fastening member is riveted to one respective mounting through hole of the metal frame shell by a stamping press. In order to prevent deformation of the metal frame shell during riveting, the metal frame shell must have a certain wall thickness, and the stamping pressure must be accurately controlled. Due to wall thickness limitation of the metal frame shell, this fastening structure cannot satisfy the requirements of a thin design.

### SUMMARY OF THE INVENTION

The present invention has been accomplished under the circumstances in view. It is therefore an object of the present invention to provide a fastening structure, which enhances connection stability and structural strength and has low profile and light weight characteristics.

To achieve this and other objects of the present invention, a fastening structure comprises a fastening structure comprises a metal plate member, and a fastening member. The fastening member comprises a shank body, a mounting flange extending around the periphery of the bottom end of the shank body and riveted to a mounting through hole of the metal plate member, and a screw hole on the shank body for the fastening of an external screw member to secure an external circuit board to the top end of the shank body at a distance from the plate member. The mounting flange has a tapered peripheral wall reducing gradually upwardly from the bottom end of the shank body toward the top end thereof and riveted to a mounting through hole of the plate member and a step located on the topmost edge of the tapered peripheral wall around the periphery of the shank body and kept in flush with the top wall of the plate member.

Further, the plate member comprises at least three arched blocks and three grooves alternatively arranged around an upper part of the peripheral wall of said mounting through hole. After insertion of the shank body of the fastening member through the mounting through hole of the metal plate member, the mounting flange of the fastening member is riveted to the arched blocks and grooves or the metal plate member, enhancing the connection stability and structural strength and avoiding loosening of the fastening member or disconnection of the fastening member from the plate member upon fastening of an external screw member to the fastening member to affix an external circuit board to the top end of the shank body of the fastening member.

### BRIEF DESCRIPTION OF THE DRAWINGS

FIG. 1 is an elevational view of a fastening structure in accordance with the present invention.

FIG. 2 is an exploded view of the fastening structure in accordance with the present invention.

FIG. 3 is a sectional side view of the fastening structure in accordance with the present invention.

FIG. 4 is a schematic sectional side view of the present invention illustrating the riveting operation (I).

FIG. 5 is a schematic sectional side view of the present invention illustrating the riveting operation (II).

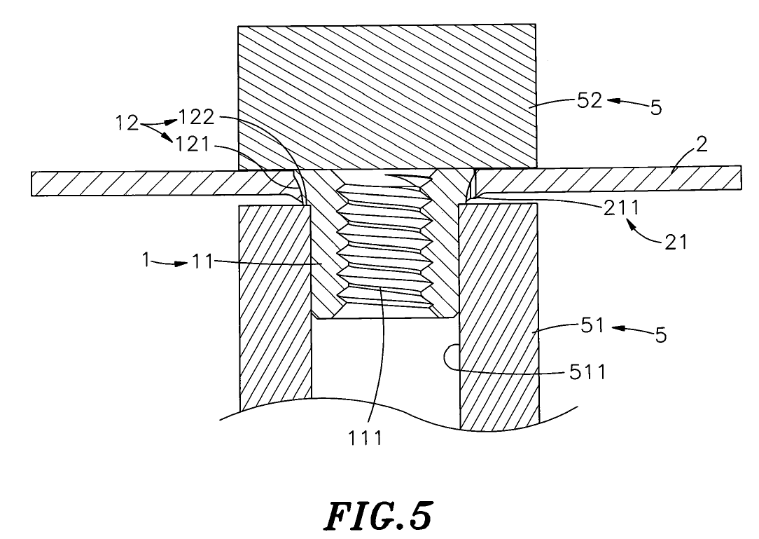

FIG. 6 is a schematic sectional side view of the present invention illustrating the riveting operation (III).

FIG. 7 is a schematic sectional side view of the present invention illustrating an application example of the fastening structure (I).

FIG. 8 is a schematic sectional side view of the present invention illustrating an application example of the fastening structure (II).

### DETAILED DESCRIPTION OF THE PREFERRED EMBODIMENT

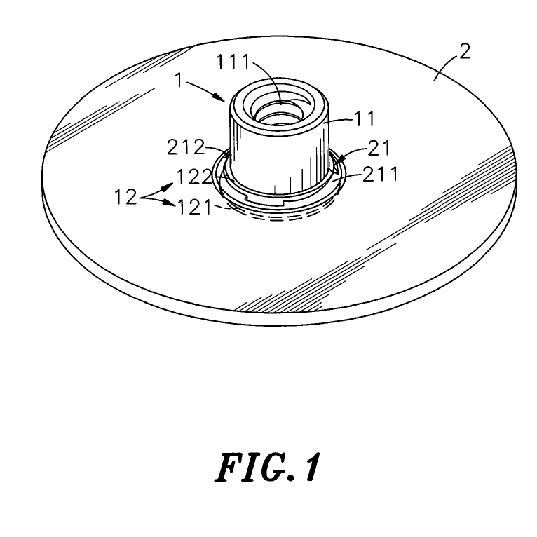

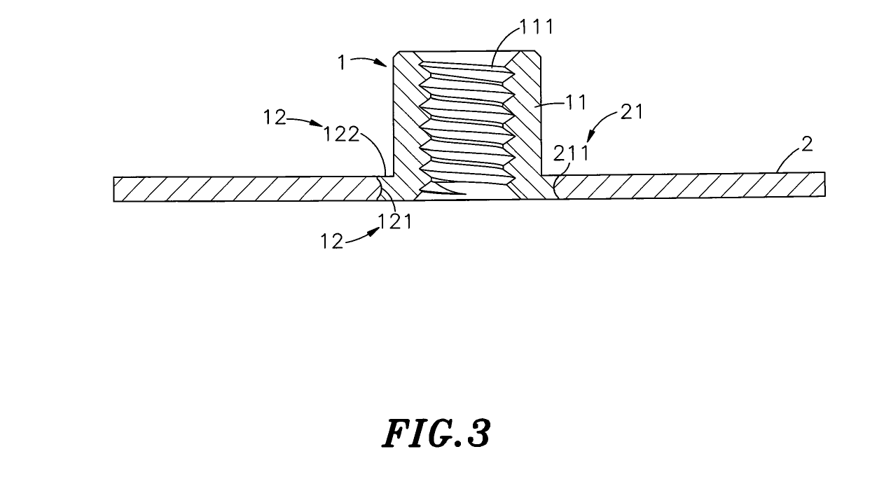

Referring to FIGS. 1-3, a fastening structure in accordance with the present invention is shown comprising a fastening member 1 and a plate member 2.

The fastening member 1 comprises a shank body 11, a screw hole 111 defined in and axially extending through two distal ends of the shank body 11, and a mounting flange 12 extending around the periphery of one end of the shank body 11. The mounting flange 12 has a tapered peripheral wall 121 that reduces gradually upwardly, and a step 122 located on the topmost edge of the tapered peripheral wall 121 around the periphery of the shank body 11.

The plate member 2 has a mounting through hole 21 for the riveting of the mounting flange 12 of the fastening member 1, a plurality of, for example, three arched blocks 211 and grooves 212 alternatively arranged around an upper part of the peripheral wall of the mounting through hole 21.

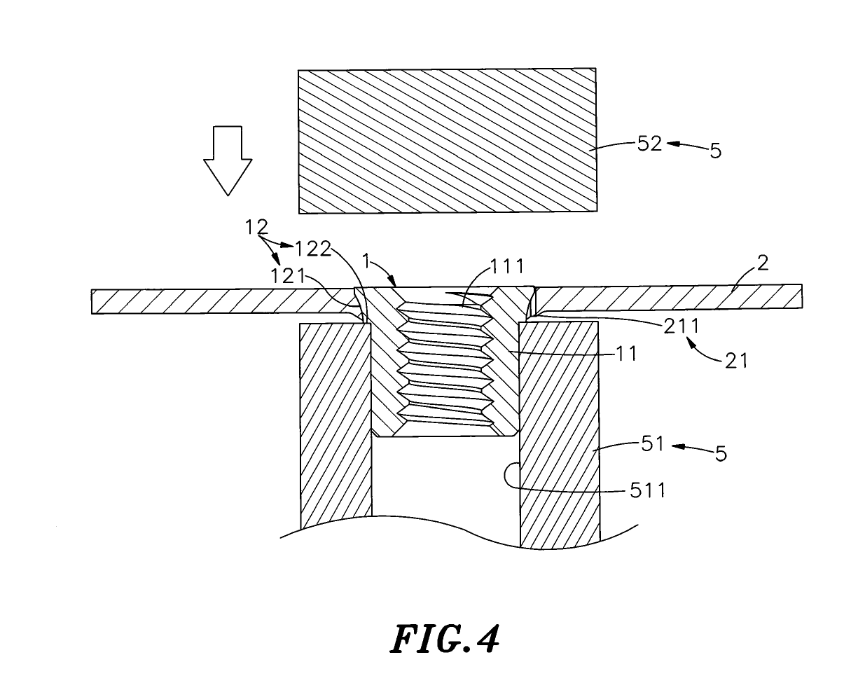

Referring to FIGS. 4˜6, when riveting the fastening member 1 to the plate member 2, aim the shank body 11 of the fastening member 1 at the mounting through hole 21 of the plate member 2 and then insert the shank body 11 of the fastening member 1 into the mounting through hole 21 of the plate member 2 in direction from the bottom side of the plate member 2 toward the top side thereof to stop the tapered peripheral wall 121 of the mounting flange 12 against the bottom edge of each of the arched blocks 211, and then attach the fastening member 1 and the plate member 2 to a shape-forming tool 5 of a stamping press (not shown), and then operate the stamping press to stamp the fastening member 1 and the plate member 2, thereby riveting the fastening member 1 to the plate member 2, During riveting, the plate member 2 is turned upside down and rested on a back-up tool 51 of the shape-forming tool 5 to keep the mounting through hole 21 of the plate member 2 in axial alignment with the cavity 511 of the back-up tool 51, and then the shank body 11 of the fastening member 1 is vertically downwardly inserted into the mounting through hole 21 of the plate member 2 to stop the tapered peripheral wall 121 of the mounting flange 12 against the bottom edge of each of the arched blocks 211 of the inverted plate member 2, and then operate the stamping press to stamp the flat surface of a punch 52 of the shape-forming tool 5 against the mounting flange 12 of the fastening member 1, thereby deforming the mounting flange 12 and forcing the mounting flange 12 into the grooves 212 in the mounting through hole 21 to the extent that the step 122 is kept in flush with the top surface of the plate member 2. Thus, the fastening member 1 is fixedly riveted to the mounting through hole 21 of the plate member 2.

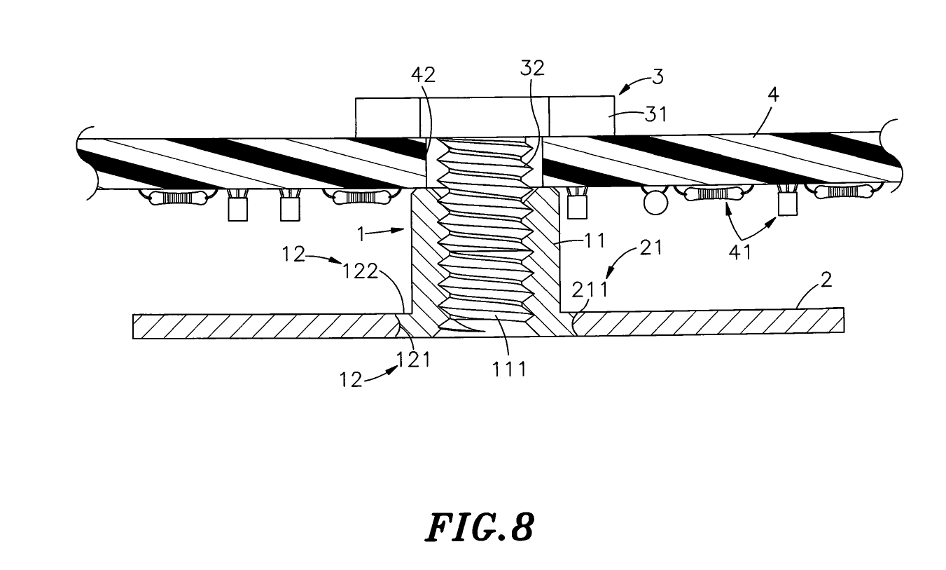

Further, the plate member 2 can be a thin, light weight and low torque metal sheet member (for example, high rigidity aluminum alloy sheet member). Thus, when riveting the mounting flange 12 to the mounting through hole 21, the tapered peripheral wall 121 of the mounting flange 12 can be accurately riveted to the bottom edge of each of the arched blocks 211 and engaged into the grooves 212, enhancing the connection stability and structural strength and avoiding loosening of the fastening member 1 or disconnection of the fastening member 1 from the plate member 2 upon threading of a screw member 3 into the screw hole 111 of the fastening member 1 (See FIG. 8).

Further, the fastening member 1 can be made of aluminum, copper, stainless steel, zinc alloy or any other metal material. The plate member 2 can be a thin, light weight and low torque metal sheet member having a thickness within the range of 0.4 mm˜0.7 mm. As stated above, the fastening member 1 is riveted to the plate member 2. However, because the riveting technique is of the known art and not within the scope of the spirit of the invention, no further detailed description in this regard is necessary.

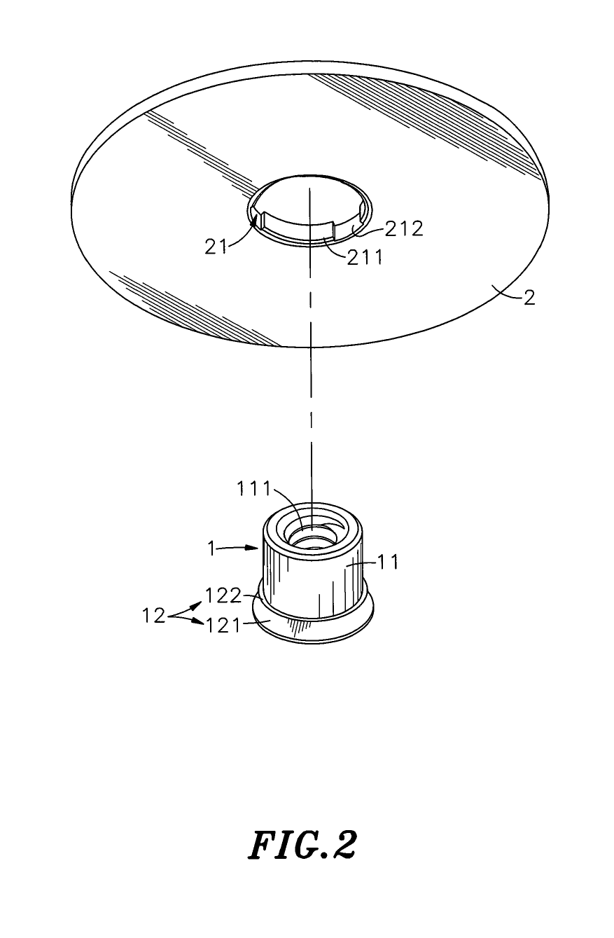

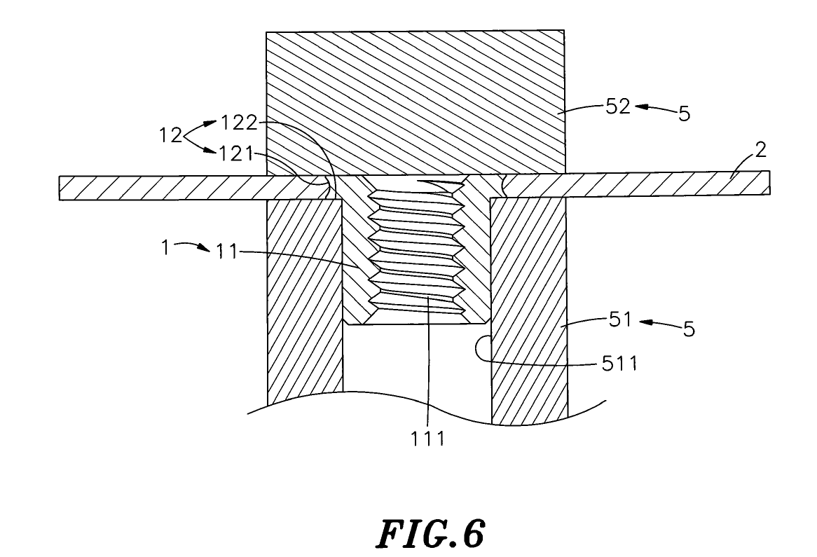

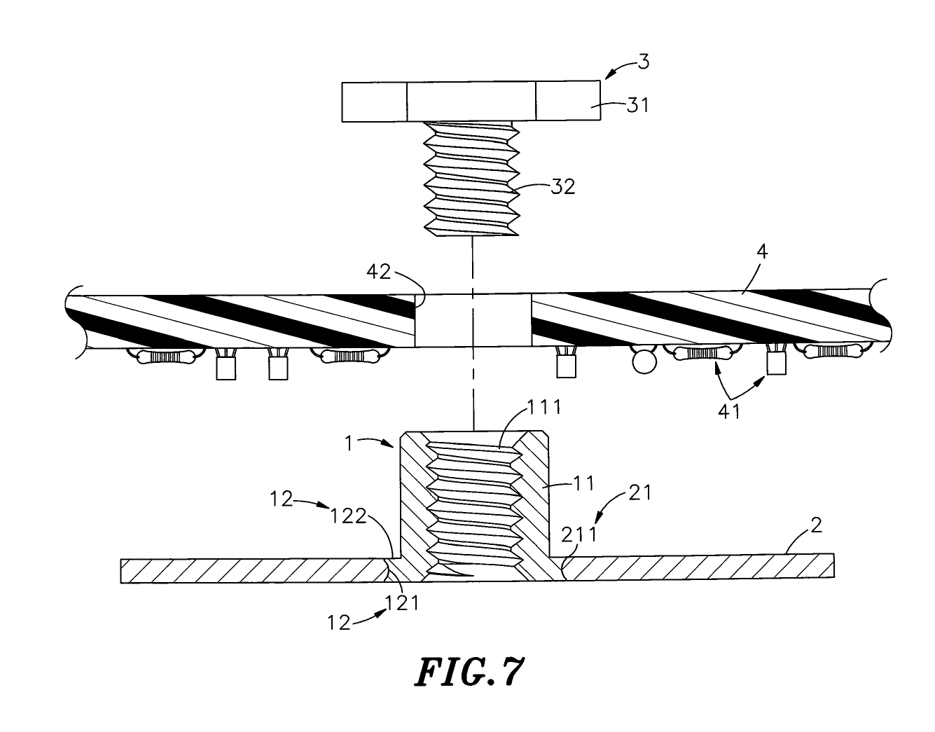

Referring to FIGS. 7 and 8 and FIGS. 2 and 6 again, the screw member 3 has a head 31 rotatable by a hand tool (for example, screwdriver), and a threaded shank 32 perpendicularly downwardly extended from the center of the bottom wall of the head 31. The threaded shank 32 is inserted through a mounting through hole 42 of a circuit board 4 carrying a circuit layout and electronic components 41 and then threaded into the screw hole 111 of the fastening member 1 to affix the circuit board 4 to the fastening member 1 and to keep the circuit board 4 at a distance from the plate member 2, avoiding direct contact between the electronic components 41 and the plate member 2 to cause a short circuit or contact failure. In actual practice, the plate member 2 provides multiple mounting through holes 21, multiple fastening members 1 are respectively riveted to the mounting through holes 21 of the plate member 2, and multiple screw members 3 are respectively mounted in respective mounting through holes 42 of the circuit board 4 and fastened to the fastening members 1 by a hand tool (for example, screwdriver) to affix the circuit board 4 to the fastening members 1 and to have the circuit board 4 be supported on the shank body 11 of the fastening members 1 and kept at a distance from the plate member 2.

As stated above, the invention provides a fastening structure comprising a fastening member 1 and a plate member 2, wherein the fastening member 1 comprises a shank body 11, a screw hole 111 defined in and axially extending through two distal ends of the shank body 11, and a mounting flange 12 extending around the periphery of one end of the shank body 11 and having a tapered peripheral wall 121 and a step 122 located on the topmost edge of the tapered peripheral wall 121 around the periphery of the shank body 11; the plate member 2 has a mounting through hole 21 for the riveting of the mounting flange 12 of the fastening member and a plurality of arched blocks 211 and grooves 212 alternatively arranged around the upper part of the peripheral wall of the mounting through hole 21. By means of riveting the mounting flange 12 of the fastening member 1 to the mounting through hole 21 of the plate member 2, a circuit board 4 can be fixedly fastened to the shank body 11 of the fastening member 1 by a screw member 3 and supported on the shank body 11 at a distance from the plate member 2.

It is to be understood that the above-described embodiments of the invention are merely possible examples of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A fastening structure, comprising:
a plate member having a mounting through hole cut through opposing top and bottom walls thereof; and
a fastening member riveted to said mounting through hole of said plate member, said fastening member comprising a shank body having opposing top and bottom ends and inserted through said mounting through hole of said plate member and a mounting flange extending around the periphery of the bottom end of said shank body, said mounting flange having a tapered peripheral wall reducing gradually upwardly from the bottom end of said shank body toward the top end thereof and riveted to said mounting through hole of said plate member and a step located on the topmost edge of said tapered peripheral wall around the periphery of said shank body and kept in flush with the top wall of said plate member.

2. The fastening structure as claimed in claim 1, wherein said fastening member comprises a screw hole axially extending though the top side and bottom side of said shank body for the fastening of an external screw member to secure an external circuit board to the top end of said shank body at a distance from said plate member.

3. The fastening structure as claimed in claim 1, wherein said plate member comprises at least three arched blocks and three grooves alternatively arranged around an upper part of the peripheral wall of said mounting through hole.

4. The fastening structure as claimed in claim 1, wherein said plate member has a thickness within the range of 0.4 mm˜0.7 mm.
